(19) United States
(12) Patent Application Publication
(10) Pub. No.: US 2014/0006241 A1
(43) Pub. Date: Jan. 2, 2014

(54) ASSET MANAGEMENT SYSTEM

(71) Applicants: Steven ROBB, Glenview, IL (US); Bernal SCHOOLEY, III, Geneva, IL (US)

(72) Inventors: Steven ROBB, Glenview, IL (US); Bernal SCHOOLEY, III, Geneva, IL (US)

(73) Assignee: Steven Robb, Rosemont, IL (US)

(21) Appl. No.: 13/719,392

(22) Filed: Dec. 19, 2012

Related U.S. Application Data
(60) Provisional application No. 61/577,228, filed on Dec. 19, 2011.

(51) Int. Cl. G06Q 40/00

(52) U.S. Cl. CPC G06Q 40/00
USPC 705/35

(57) ABSTRACT

An asset management system comprises a database storing data for assets and asset related attributes including maintenance or lease contracts. An input device automatically reads identifying information for an asset. A programmed processing system is operatively associated with the database and the input device implementing an asset management portal (AMP). The AMP includes a user interface wherein the programmed processing system receives asset identifiers from the input device to enable real-time management of asset related maintenance release contracts via the user interface.

### CROSS-REFERENCE TO RELATED APPLICATIONS

This application claims priority of provisional application no. 61/577,228, filed Dec. 19, 2011.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This invention relates to asset management systems and, more particularly, to a completely integrated life-cycle asset management system.

### BACKGROUND

Technology environments are more complex today than ever. It is necessary for businesses to find the best solutions for their organizations based on their needs and to help track and manage equipment. Also, it is necessary to have optimized contracts to maintain assets and to provide continued asset and maintenance management throughout the product life cycle.

Known asset management systems are designed to manage maintenance contracts, equipment leases and disposal information and asset information. These systems are used to plan and manage strategic financial and operational decisions efficiently in a timely manner. Such systems can generate reports and set up notifications for better planning and processing. Additionally, the systems communicate securely with existing systems to ensure best processes are utilized and nothing is compromised.

With current systems, when a new product is purchased it is necessary to manually enter the product information into the asset management system. Likewise, any updates to maintenance contracts must be entered manually. This can occur, for example, if a new product is purchased to replace an existing product under an ongoing maintenance agreement. Requirements for manual entry of information can introduce chances of errors and is often time consuming.

The present invention is directed to improvements in asset management systems.

### SUMMARY

In accordance with the invention, an exemplary asset management system uses a scanning apparatus to scan an asset identifier (serial number, asset tag, etc) via 2D or 3D barcode, RFID (radio frequency identification), or NFC (near field communication) for interactive access over a wireless network to enable real-time management of maintenance and lease contracts.

Broadly, there is disclosed herein an asset management system comprising a database storing data for assets and asset related attributes including maintenance or lease contracts. An input device automatically reads identifying information for an asset. A programmed processing system is operatively associated with the database and the input device implementing an asset management portal (AMP). The AMP includes a user interface wherein the programmed processing system receives asset identifiers from the input device to enable real-time management of asset related maintenance release contracts via the user interface.

It is a feature that the input device comprises a scanning apparatus.

It is another feature that the programmed processing system comprises a web server communicating with a remote computer over a network.

It is a further feature that the remote computer comprises a smartphone.

It is still a further feature that the remote computer comprises a tablet.

It is yet another feature that the programmed processing system includes an asset management engine that manages and coordinates communication among foundational components, support components and equipment components.

It is yet another feature that the foundational components comprise available modules selected from among contract maintenance systems, lease schedule systems, equipment disposal systems and price quoting systems. The asset management system may respond to and evaluate events received from the input device and coordinate with the available modules to perform actions and instruct other components to perform actions.

It is an additional feature that the asset management engine enables the user to add a new asset to maintenance or lease contract stored in the database and the database is updated in real time.

It is an additional feature that the asset management engine enables the user to change a site location for an asset stored in the database and the database is updated in real time.

It is still another feature that the asset management engine enables the user to automatically transmit a request for a maintenance quote for an asset stored in the database.

Other features and advantages will be apparent from a review of the entire specification, including the appended claims and drawings.

### BRIEF DESCRIPTION OF THE DRAWINGS

FIG. 1 is a generalized block diagram of an asset management system in accordance with the invention;

FIG. 2 is a block diagram illustrating sub-systems of an asset management portal (AMP) used in the system of FIG. 1;

FIG. 3 is a block diagram illustrating the AMP interfacing with third party web apps;

FIG. 4 is a flow diagram illustrating operation of the AMP; and

FIGS. 5-13 are a series of screen displays illustrating a user interface for the AMP in accordance with the invention.

### DETAILED DESCRIPTION

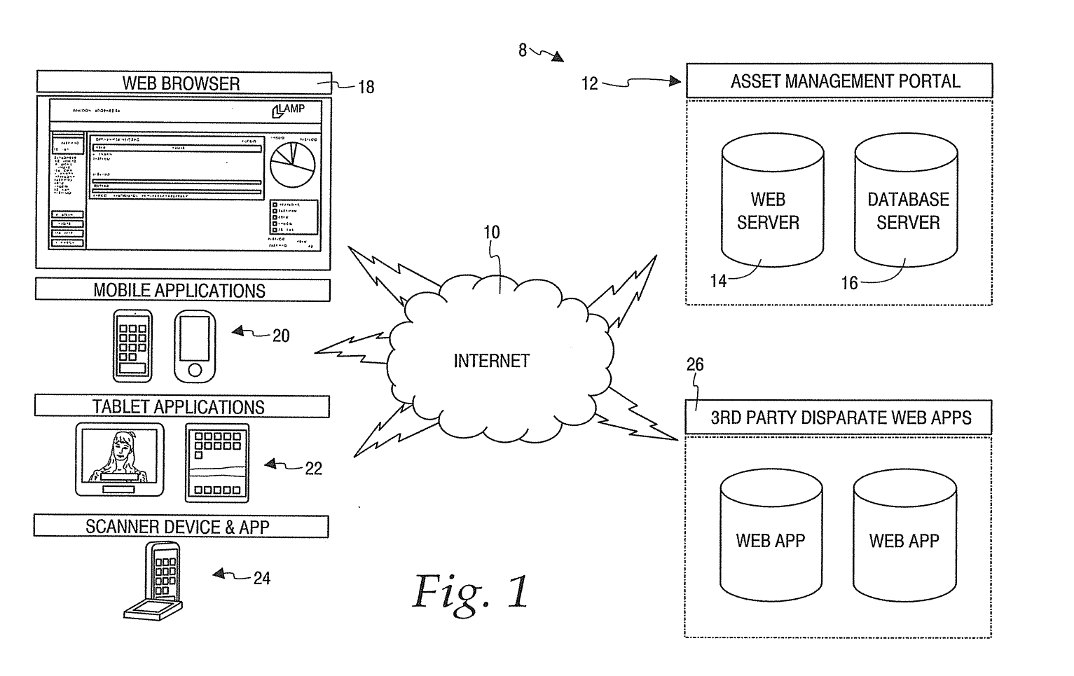

An exemplary asset management system 8, see FIG. 1, is a completely integrated life-cycle asset management system 8 where every element of the entire system is fully integrated to every other element of the entire system to intelligently deliver an end-to-end life-cycle asset management solution. Moreover, the exemplary asset management system 8 is created in a way where information is processed, generated, or presented to the end user based on an event or series of events that occurred within the system or communicated with external systems, and is processed by the exemplary system and intelligently delivered to other life-cycle asset management subsystems or components enabling the end users to make intelligent decisions as it relates to the asset life-cycle.

In order to provide an end-to-end life-cycle asset management solution, FIG. 1 illustrates how the life-cycle asset management system 8 is connected over the internet 10, or intranet, with the ability to integrate into many disparate solutions through various application programming interfaces (APIs) and provides a central repository database for an asset or asset related data attributes. (In some embodiments, the system functionality is provided over one or more servers). An Asset Management Portal (AMP) 12 is the apparatus that ties together internal based services and external disparate services to deliver the end-to-end life-cycle asset management solution.

In FIG. 1, the AMP 12 is hosted on a web server 14 and stores transactional and relational information in its database server 16. The web server 14 is connected to the internet 10 via a multitude of internet languages such as Internet Protocol (IP), Hypertext Transfer Protocol (HTTP), Hypertext Transfer Protocol Secure (HTTPS), and other Internet based protocols. In addition, FIG. 1 shows the client side web browser 18 interacting with the server side web server(s) 14. The client side is illustrated by either the web browser 18 that is located on a user's computer or on a mobile device that is internet browser capable.

The user interacts through the web browser 18 and interacts with the server-side over the internet 10. In addition, the user can interact with the web server 14 through a series of native mobile 20 or tablet 22 applications that combine the experience of the web server or server-side native to the operating system of that end device e.g. Android, iOS, Windows, Blackberry, etc. This experience can be solely native or mixed where native is the starting point and the interaction within the native application is a web browser session with the web server 14. The user can also interact using a scanner 24, also referred to herein as a scanning apparatus. The scanning apparatus 24 can be a standalone scanning device or a scanning app on a smartphone or tablet or the like.

The AMP 12 also provides additional web services to integrate into 3^{rd} party disparate web servers or web applications 26 to unify asset collection and related information. AMP web service is a bi-directional communication service to properly communicate asset related attributes within the AMP 12 and 3^{rd} Party disparate web servers and web applications 26.

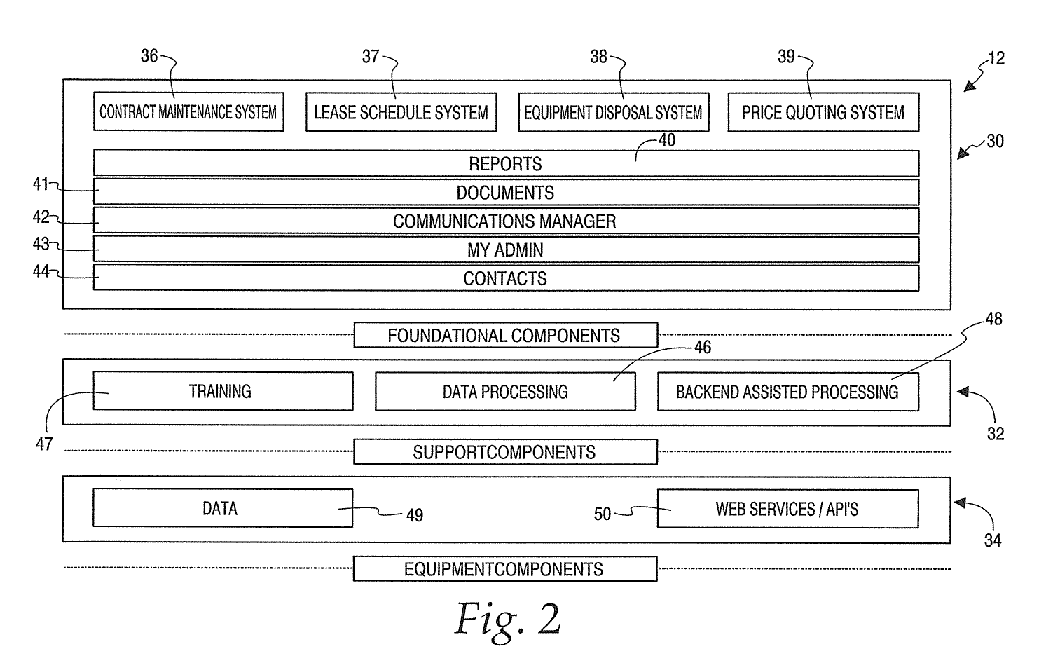

The exemplary system is designed to support the complete asset life-cycle management process. In FIG. 2, the AMP 12 is comprised of multiple subsystems that correspond to different stages and processes during the asset life-cycle to process. The system shown in FIG. 2 is divided into three major areas: foundational components 30, support components 32, and equipment components 34. The foundational components 36 are made up of nine subsystems or modules that include a contract maintenance system 36, a lease schedule system 37, an equipment disposal system 38, a price quoting system 39, a reports system 40, a document management system 41, a communications management system 42, an admin management system 43, and a contacts system 44.

The first foundational component includes the contract maintenance system 36. It helps users track all their maintenance contract information. It empowers the users to search easily by location, serial number, and manufacturer. It also provides the users the ability to track and view moves, adds, and/or changes. It also provides the ability to manage multiple assets and multiple vendors under a unified user interface.

The second foundational component includes the lease schedule system 37. It empowers users to readily access all of their lease information online. It allows users to search by location, maturity dates, purchase orders, and/or serial number. It also provides users the ability to track information by lease schedules, maturity dates, and create alerts based on this information.

The third foundational component includes the Equipment Disposal System 38. It helps users manage the disposition process including initialization of the bill of laden, management of disposal type, and process tracking. It allows users to track equipment by lot numbers, location, and/or manufacturer(s). It enables users to manage and view equipment values and balances, and view certifications of wipe and disposition.

The fourth foundational component includes the Price Quoting System 39. This tool provides users with the ability to request quotes for hardware from multiple vendors. The user has the option to either request a hardware or maintenance quote, leasing quote, or disposal quote from a single interface to streamline the entire asset life-cycle management process.

The fifth foundational component includes the report management system 40. The report management system provides a series of reports across the four main subsystems of the contract maintenance, lease schedule, equipment disposal, and price quoting. For example, within contract maintenance system, reports can be created to view managed assets, track credits, etc. . . . and these reports can be exported to excel or pdf.

The sixth foundational component includes the document management system 41. The document management system provides the ability to maintain and manage critical documents relating to the four main subsystems. This helps users increase productivity and collaboration to support and manage the complete asset life-cycle management process.

The seventh foundational component includes the communications management system 42. The communications management system provides the ability to manage the integration with 3^{rd} Party web applications 26 and automate the exchange of assets related to and between or among the various systems and subsystems. This subsystem is leveraged across the four main subsystems.

The eighth foundational component includes the admin management system 43. The admin management system enables users to manage information related to contracts, sites, contacts, links, custom fields, and users. This provides users access to deeper management information related to assets such as contracts, sites, contacts, links, custom fields, and users. The admin management system is leveraged across the four main subsystems.

The ninth foundational component includes contact management system 44. The contact management system provides the ability to maintain and manage different users to access and assign permissions and rights to different authenticated users. The contact management system is leveraged across the four main subsystems.

To support the foundational components, the system provides an integrated support system that further facilitates the complete asset life-cycle management process. The three support components include data or batch processing 46, training 47, and backend assisted processing 48. These subsystems or processes support the different phases of the asset life-cycle management process.

The first support component includes data processing 46. As the asset information is collected relating to the organization, it is processed and uploaded into the AMP 12.

The second support component includes training 47. Once the asset related data has been uploaded into the AMP 12, a series of onsite and/or WebEx trainings occur to ensure the user is knowledgeable about how to use the service. The training sessions ensure the user can fully utilize the system.

The third support component includes backend assisted processing 48. Backend assisted processing ensures data integrity, data normalization, and data accuracy with the asset manufacturers. The backend assisted processes are both manual and automated to ensure the accuracy of the asset related to the manufacturers' own database information relating to the user's assets.

Two equipment components, data communications 49 and web services/application programming interfaces (APIs) 50, are included in the exemplary system. The data services 49 and the web services (APIs) 50 are used both by the foundational and support components to support the subsystems (modules) and processes to provide a complete end-to-end asset life-cycle management process.

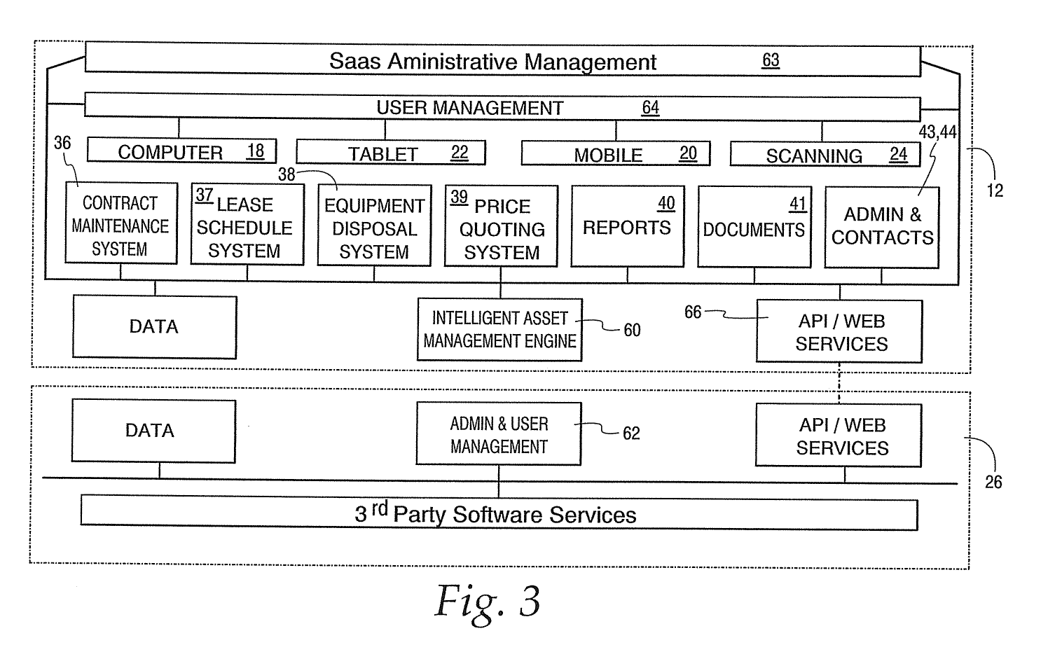

FIG. 3 illustrates the AMP 12 communicating with the external 3^{rd} Party web applications 26. In FIG. 3, 3^{rd} Party web applications complete the embodiment of the exemplary system in FIG. 2.

The key elements in FIG. 3 are the scanning apparatus 24 and Intelligent Asset Management Engine (IAME) 60. In the 3^{rd} party web apps 26, an administrative management system 62 enables the Software as a Service (SaaS) or Cloud-based service provider 63 to administrator, manage, and provision services for its customers. The user management 64 enables users of the service to interface and interact with the AMP 12.

More specifically, the user can interact with the various subsystems (modules) within the AMP 12 via the computer web browser 18. In addition, the user can interact with the AMP 12 through a series of native mobile 20 or tablet 22 applications that combine the experience of the web browser experience native to the operating system of that end device e.g. Android, iOS, Windows, Blackberry, etc. This experience can be solely native or mixed, where native is the starting point and the interaction within the native application is a web browser session with the web server.

Within the user management 64, the scanning apparatus 24 provides a new user experience and paradigm shift as it relates to the asset life-cycle management process. Specifically, use of a scanning apparatus 24 to scan an asset identifier (serial number, asset tag, etc) via 2D or 3D barcode, RFID (radio frequency identification), or NFC (near field communication) for interactive access over a wireless network to enable real-time management of maintenance or lease contracts.

In the past, users had to hand-type serial numbers of assets that they were managing into systems. Often, this manually entry would lead to a high rate of errors and inaccurate data. As an organization grows the IT infrastructure grows. Today's infrastructures include many types of equipment in various locations increasing complexities that challenge the goals of cost management, compliance and increased productivity.

More importantly, if an organization is not able to effectively and efficiently manage its IT infrastructure and the maintenance and lease contracts associated with assets, it could end up costing an organization hundreds of thousands of dollars. At the same time, if asset information is inaccurately tied to a maintenance or lease contract and an outage occurs, extended outages and costs may occur due to the manufactures inability to deliver the asset to the proper site location in a timely manner.

The scanning apparatus 24 extends the reach of the AMP 12 and enables ubiquitous access to critical asset related information anywhere at any time. With the scanning apparatus 24 seamlessly enabling the user to input and output critical asset identifier information (serial number, asset tag, etc) via 2D or 3D barcode, RFID (radio frequency identification), or NFC (near field communication) for interactive access over a wireless network to enable real-time management of maintenance contract or lease contracts, the Intelligent Asset Management Engine 60 intelligently routes and communicates with other subsystems within the AMP 12 or external 3^{rd} Party web applications 26.

The IAME 60 is the intelligent broker that manages and coordinates communication among the various subsystems and external 3^{rd} Party web applications 26 via web services or application programming interfaces (APIs) 66. The IAME 60 is the glue that ties together many of the AMP 12 subsystems and external 3^{rd} Party web applications 26 and extends access to this information to multitude of user interfaces such as a browser on a computer, native applications on mobile or tablet devices, and especially the scanning apparatus.

The IAME 60 works closely with the scanning apparatus 24 and is able to control the flow of data in the system and intelligently act on information based on different events and actions that occur on the scanning apparatus. As these events or actions occur on the scanning apparatus, the IAME 60 evaluates the event and makes a determination on the event based on factors such as, but not limited to the context of the event. Based on this information, the IAME 60 will coordinate with the other components to perform other actions and instruct the other components to carry out actions within or outside the system. The IAME 60 manages how the data is accessed and manipulated within the system and on the scanning apparatus 24. The IAME 60 makes intelligent decisions to give access and read/write capabilities to different components within the system.

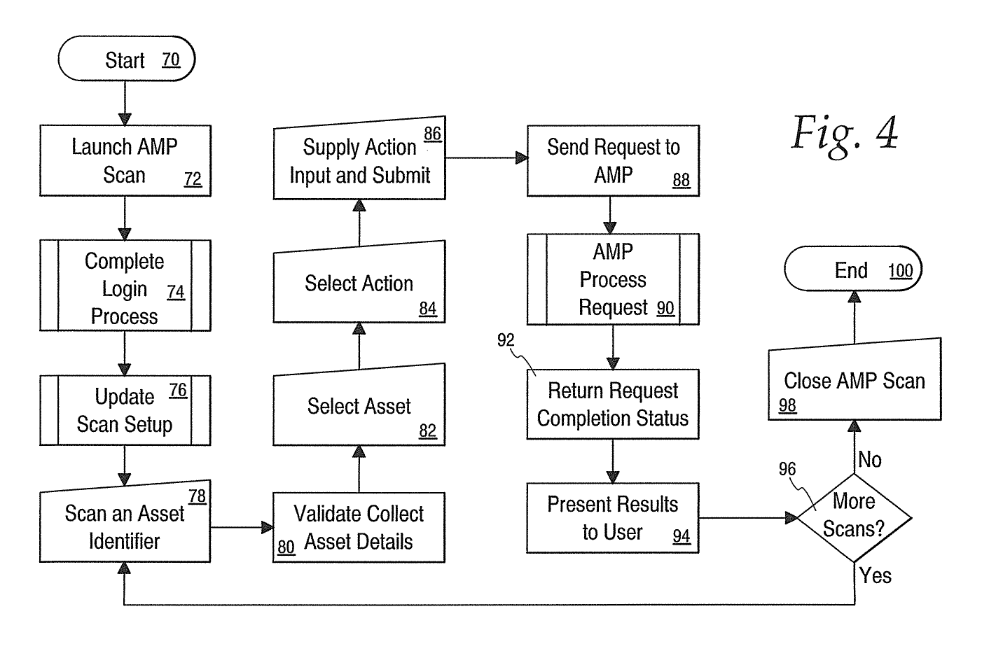

Referring to FIG. 4, a flow diagram illustrates operation of the AMP 12. This software is implemented on the web server 14, see FIG. 1, using data stored in the database server 16. This application may be implemented, for example, on the web browser 18, the mobile apps 20 or tablet apps 22, as desired.

The operation begins at a start node 70 when the browser or app, or the like, referred to as an “AMP scan”, is launched at a block 72. At a block 74 the user completes a log in process. This is a standard process for the user to enter in a user name and password. The user then updates the scan set up at a block 76 and scans an asset identifier at a block 78, using the scanning apparatus 24. The system then validates and collects asset details at a block 80 for available assets in the system. The user can select an asset at a block 82 and then select an action to be taken at a block 84. The system then supplies action input from the user which may identify equipment, location and the like, and submits this information via a request to the AMP 12 at a block 88. The AMP 12 processes the request at a block 90 and returns a request completion status at a block 92. The results are then presented to the user at a block 94. A decision block 96 determines if the user has more scans to complete. If so, then the programmer returns to the block 78 to scan an asset identifier for another asset. If not, then the AMP scan routine is closed at a block 98 and the routine ends at a node 100.

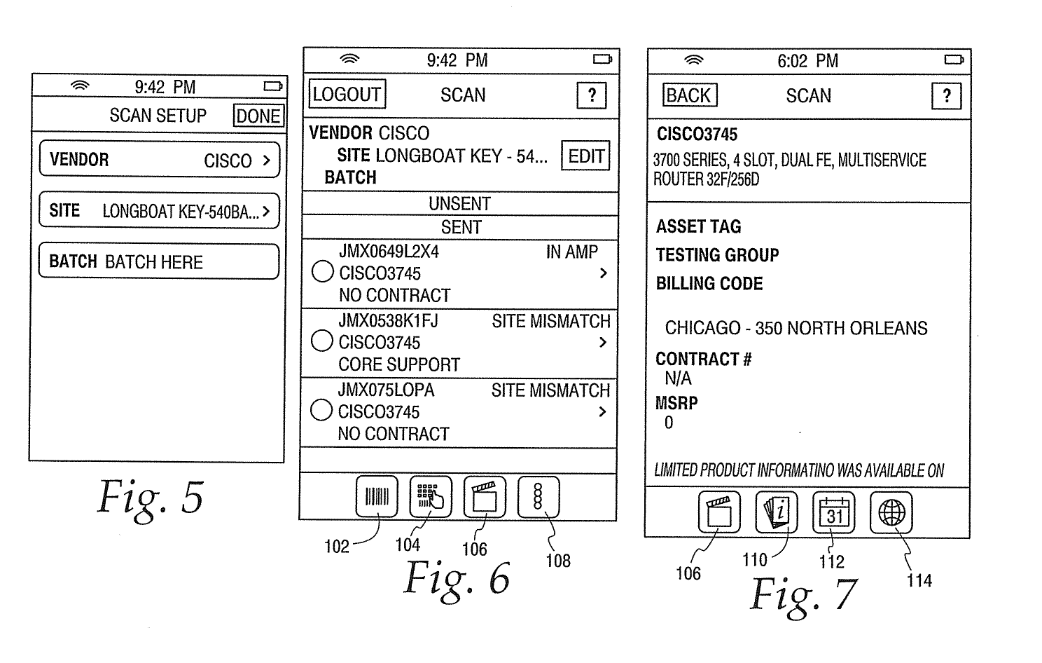

The operation of the asset management system 8 under the logic of FIG. 4 is now described in greater detail with respect to the user interface provided via the AMP 12 to the user, as illustrated in FIGS. 5-13 and discussed below.

The use of a scanning apparatus 24 to scan an asset identifier (serial number, asset tag, etc) via 2D or 3D barcode, RFID (radio frequency identification), or NFC (near field communication) for interactive access over a wireless network to enable real-time management of maintenance contract or lease contracts that it is tightly coupled with the AMP 12 enables ubiquitous access to critical asset related information anywhere at any time and provides the user the ability to seamlessly input asset related information by a single touch of the scanning apparatus 24. To start the scanning process, the user completes the login process, as at 74, by providing his or her username and password. Once the user submits this information, the AMP 12 authenticates the user and allows them access to the appropriate information relating to his or her account. If the user has lost his or her password, the AMP 12 allows the user to recover his or her login.

Before the scanning process begins, it is important for the user to update the scan setup at a block 76. The user selects settings such as current vendor, site and if the user will be scanning a batch of assets. This is illustrated with the smartphone screen display of FIG. 5. The user can click a button to change the values. The vendor setting is required for the scanning apparatus to perform serial number lookups. New assets added to the AMP 12 will be tagged with this value. The site setting is how the user indicates where the devices are located. This site will be applied to any new assets. The site value for any assets already in the AMP 12 will be compared with this site setting to verify that the device is listed correctly. The batch setting is a simple text label that is applied to each scan and enables quick selection of scan records when viewing them in the AMP 12 website. An example of a batch would be building and floor numbers when doing an audit.

Once the proper scanning apparatus settings have been saved, the user can use the scanning apparatus 24 to perform an audit, to check the end-of-life dates of assets within the datacenter, to get an asset description, to RMA an asset, to process a Spare Swap, etc. The user also has the ability to perform a bulk scan of multiple assets that have been just delivered on a pallet. In the past, when a pallet of assets appeared, IT employees would have to manually input asset identifiers. With the scanning apparatus 24, the user is able to scan an asset identifier (serial number, asset tag, etc) via 2D or 3D barcode, RFID (radio frequency identification), or NFC (near field communication) for interactive access over a wireless network in a bulk fashion and sync this information in real-time to a maintenance or least contract. By bulk scanning hundreds or thousands of assets, the employee is able to automate the input increasing productivity and increasing asset identifier accuracy.

Once an asset has been scanned by the scanning apparatus 24, the asset's information will be displayed as shown in FIG. 6. The display shows the asset identifier, asset part number, contract type, and whether the asset is current in the AMP 12, if there is a site mismatch, or If the asset currently not in AMP 12. Once a serial number is scanned, it is placed in the unsent section of the scan list. These assets are queued and waiting to be sent to the AMP 12 for validation. The asset information is sent when an internet connection is available. If assets remain in this section for an extended period of time, it likely means that there is a problem communicating with the AMP web server 14 via the wifi network or that the wifi network is not connected.

Scans that have been sent to the AMP 12 are validated against multiple databases to collect as much information as possible and return the data to the AMP Scan. The circle on the left of an asset allows it to be selected so that actions can be applied.

If a photo of the item is available, it will be displayed to the right of the circle. Next an asset may have a photo and then three lines of text. The first line is the serial number that was scanned, the second is the part number, if discovered, during the validation and the third line shows the contract that for the asset if it has one. In the upper right corner of each scanned asset, there is a status message that displays one of the following three values—In AMP; Site Mismatch; or Not in AMP. In LAMP means that the serial number was found in AMP and that the scan site indicated in the header and the site for the asset in AMP match. Site Mismatch status indicates that the serial number was found in AMP but the scan site indicated in the header did not match the site that was recorded in AMP. Not in AMP indicates that the serial number was not found in AMP during the validation. This status indicates that a user should verify that the serial number scanned properly and that the barcode was indeed for the serial number and not the part number as some devices have more than one barcode on them.

The apps may include various soft buttons which are illustrated in the bottom of several of the display figures, particularly FIGS. 6-8. A scan serial number button 102 activates the bar code scanner. A manual input button 104 allows a user to type in a serial number when a bar code is not available or is not able to be scanned by the scan device. An action button 106 is grayed out to begin with and activated once one or more assets are selected in a scan list. A deselect all button 108 is active when one or more assets are selected in the scan list and clicking it removes the selection check mark from all assets. An asset information button 110 switches the page to the asset information details page if not already selected. An end of life button 112 switches the page to the end of life and migration options detail page. Finally, a web site search button 114 opens a web browser window that executes a search on a product web site for the part number of the asset and displays information found.

Once an asset or leased asset is scanned by the scanning apparatus 24, the user can view product details as seen in FIG. 7. The asset or leased asset will have information including but not limited to asset tag, testing group, billing code, site location, contact number, MRSP, Product Details, scanning individual, date scanned, End of Life dates, and migration options.

A photo will be shown if available. The first line shows the part number and below that is the product description for the asset. This section can be scrolled and shows the available data for this asset. There are two different pages of data that can be displayed in this section, the asset information or the end of life and migration data. These pages are selected by clicking the buttons.

As asset can have numerous actions available which would be shown in bold with unavailable actions grayed out. Among these actions are actions to remove the asset from the AMP scan list, add the assets to the AMP scan list, and request a maintenance quote for a current asset. Actions available for modification will be active including part number, region, contract, term and quantity. A user can select appropriate items. Additional available actions are to change the site to update AMP with a new site for the asset and change contract to request that the asset be added to a contract or switched to a different contest. The user can submit an RMA update for an asset. The user scans or enters the new serial number, enters an RMA number and any notes. An additional action includes a spare swap update for the asset. The user scans or enters the new serial number and any notes. Finally, there is a change custom field action that allows the updated pre-defined custom fields for the asset.

In the management of maintenance contracts for assets and leases for assets, the process of adding asset related data can be daunting. Generally, when a pallet of assets arrives at an organization, there is someone from the IT staff manually entering the asset related data. This generally leads to high a number of manual hours for IT employees in processing this data and generally a high rate of error when manually entering asset related data.

With the scanning apparatus, IT staff can simply scan the asset identifier (serial number, asset tag, etc) via 2D or 3D barcode, RFID (radio frequency identification), or NFC (near field communication) for interactive access over a wireless network to enable real-time asset data entry as it relates to maintenance contracts for assets and leases for assets.

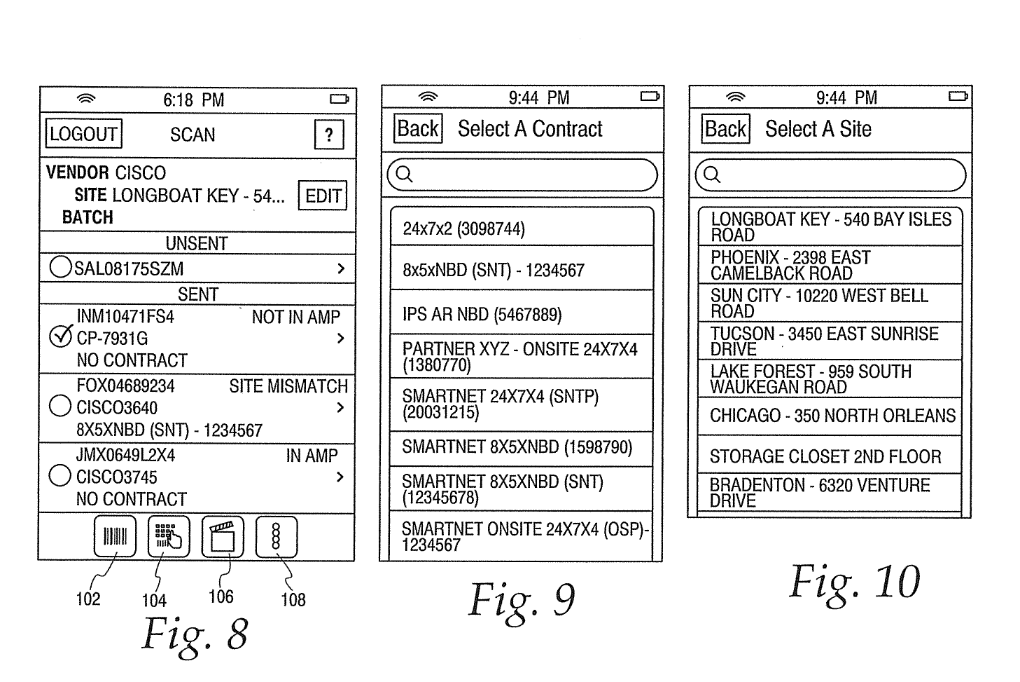

The scanning apparatus 24, which communicates real-time with the AMP 12, may respond that the asset is not in the AMP, see FIG. 8. The user can now select the “Not In AMP” asset and select an action item to add the asset to AMP.

Once the user selects, “Add to AMP”, the scanning apparatus 24 responds with a confirmation dialog message to confirm whether or not the user wants to add the asset to AMP. The user either selects Yes or No to add or not add the asset to AMP. The scanning apparatus 24 eliminates the need for IT employees to manually enter asset related data and increase the accuracy of capturing asset related data to maintenance contracts for assets and leases for assets.

Once the user uses the scanning apparatus 24 to scan an asset that is already in AMP or after adding the asset to AMP, the user has the option to initiate the process whereby the asset is either added to a contract in the case where the asset was not on a maintenance contract, or change which contract the asset is on, see FIG. 9. The scanning apparatus submits the action to AMP which updates the database in real-time and either automatically notifies the vendor or creates a ticket for the backend assisted processing team to complete the action manually.

Once the user uses the scanning apparatus 24 to scan an asset that is already in AMP or after adding the asset to AMP, the user has the option to initiate the process whereby the asset data is updated to reflect that the asset is at a new site or being moved to a new site, see FIG. 10. The scanning apparatus 24 submits the action to AMP which updates the database in real-time and either automatically notifies the vendor or creates a ticket for the backend assisted processing team to complete the action manually.

The user also has the option to initiate a process whereby the asset data is updated to change or to add additional information not previously recorded. The scanning apparatus submits the action to the AMP 12 which updates the database in real-time.

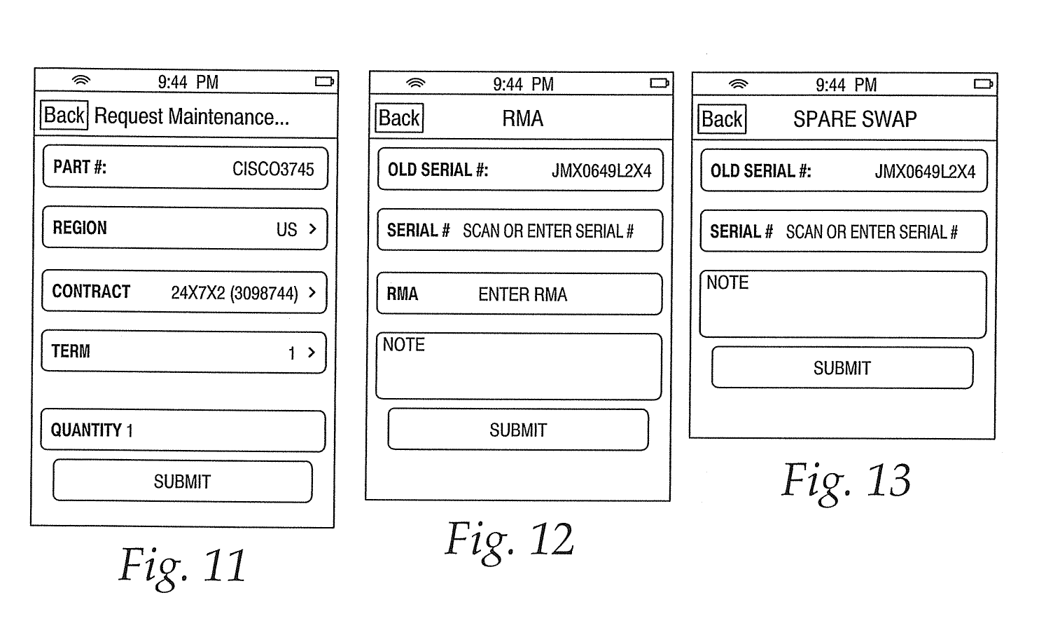

Once the user uses the scanning apparatus 24 to scan an asset that is already in AMP or after adding the asset to AMP, the user has the option to initiate a request for a maintenance quote, see FIG. 11. As part of the request, the user provides the region where the maintenance will be used, the appropriate contract the device is being added to, the term of the request and the quantity of devices should they have more than one. The scanning apparatus submits the action to AMP which calculates a price in real-time for the requested maintenance and immediately returns the results to the scanning apparatus 24. The scanning apparatus 24 then displays the pricing details for the maintenance quote.

Once the user uses the scanning apparatus 24 to scan an asset that is being replaced as part of RMA (return merchandise authorization. The user selects the RMA action, see FIG. 12, and is then prompted to enter or scan the replacement device, the RMA number provided by the vendor and optionally enter additional notes. The scanning apparatus 24 submits the action to the AMP 12 which updates the database 16 in real-time and either automatically notifies the vendor or creates a ticket for the backend assisted processing team to complete the action manually.

Once the user uses the scanning apparatus 24 to scan an asset that is being replaced with a spare, the user selects the Spare Swap action, see FIG. 13, and is then prompted to enter or scan the replacement device and optionally enter additional notes. The scanning apparatus 24 submits the action to the AMP 12 which updates the database 16 in real-time and either automatically notifies the vendor or creates a ticket for the backend assisted processing team to complete the action manually.

The user can use the scanning apparatus 24 to scan a leased asset. The user then has the option to schedule the leased asset for return. The scanning apparatus submits the action to the AMP 12 which updates the database in real-time and either automatically initiates the return process or creates a ticket for the customer service team to complete the action manually.

The user also has the option to request a lease extension. The scanning apparatus 24 submits the action to the AMP 12 which updates the database 16 in real-time and either automatically initiates the lease extension process or creates a ticket for the customer service team to complete the action manually.

The user further has the option to request a buy-out figure for the asset. The scanning apparatus 24 submits the action to the AMP 12 which either calculates the price in real-time or forwards the request to the customer service team to process the request manually. The scanning apparatus then display the buy-out details or informs the user that their request has been sent to customer service for processing.

Thus, as described, the asset management system 8 is a completely integrated life-cycle asset management system 8 where every element of the entire system is fully integrated to every other element of the entire system to intelligently deliver an end-to-end life-cycle asset management solution.

It will be appreciated by those skilled in the art that there are many possible modifications to be made to the specific forms of the features and components of the disclosed embodiments while keeping within the spirit of the concepts disclosed herein. Accordingly, no limitations to the specific forms of the embodiments disclosed herein should be read into the claims unless expressly recited in the claims. Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. An asset management system comprising:
a database storing data for assets and asset related attributes including maintenance or lease contracts;
an input device for automatically reading identifying information for an asset; and
a programmed processing system operatively associated with the database and the input device implementing an asset management portal (AMP), the AMP including a user interface wherein the programmed processing system receives asset identifiers from the input device to enable real-time management of asset related maintenance or lease contracts via the user interface.

2. The asset management system of claim 1 wherein the input device comprises a scanning apparatus.

3. The asset management system of claim 1 wherein the programmed processing system comprises a web server communicating with a remote computer over a network.

4. The asset management system of claim 3 wherein the remote computer comprises a smartphone.

5. The asset management system of claim 3 wherein the remote computer comprises a tablet.

6. The asset management system of claim 1 wherein the programmed processing system includes an asset management engine that manages and coordinates communication among foundational components, support components and equipment components.

7. The asset management system of claim 6 wherein the foundational components comprises available modules selected from among contract maintenance systems, lease schedule systems, equipment disposal systems and price quoting systems.

8. The asset management system of claim 7 wherein the asset management engine responds to and evaluates events received from the input device and coordinates with the available modules to perform actions and instruct other components to perform actions.

9. The asset management system of claim 1 wherein the asset management engine enables the user to add a new asset to maintenance or lease contracts stored in the database and the database is updated in real-time.

10. The asset management system of claim 1 wherein the asset management engine enables the user to change a site location for an asset stored in the database and the database is updated in real-time.

11. The asset management system of claim 1 wherein the asset management engine enables the user to automatically transmit a request for a maintenance quote for an asset stored in the database.

12. An asset management system comprising:
a database storing data for assets and asset related attributes including maintenance or lease contracts;
a scanner for reading identifying information for an asset; and
a programmed processing system operatively associated with the database and the scanner implementing an asset management portal (AMP), the AMP including an asset management engine that manages and coordinates communication among foundational components, support components and equipment components and uses a user interface, wherein the programmed processing system, responsive to receiving an asset identifier from the scanner, implementing real-time management of asset related maintenance or lease contracts via the user interface.

13. The asset management system of claim 12 wherein the programmed processing system comprises a web server communicating with a remote computer over a network.

14. The asset management system of claim 13 wherein the remote computer comprises a smartphone.

15. The asset management system of claim 13 wherein the remote computer comprises a tablet.

16. The asset management system of claim 12 wherein the foundational components comprises available modules selected from among contract maintenance systems, lease schedule systems, equipment disposal systems and price quoting systems.

17. The asset management system of claim 16 wherein the asset management engine responds to and evaluates events received from the scanner and coordinates with the available modules to perform actions and instruct other components to perform actions.

18. The asset management system of claim 12 wherein the asset management engine enables the user to add a new asset to maintenance or lease contracts stored in the database and the database is updated in real-time.

19. The asset management system of claim 12 wherein the asset management engine enables the user to change a site location for an asset stored in the database and the database is updated in real-time.

20. The asset management system of claim 12 wherein the asset management engine enables the user to automatically transmit a request for a maintenance quote for an asset stored in the database.
